(19) United States
(12) Patent Application Publication
(10) Pub. No.: US 2004/0182587 A1
(43) Pub. Date: Sep. 23, 2004

(54) Signal processing and control device for a power torque tool

(76) Inventors: Lutz May, Gelting (DE); Yves Antier, Charlotte, NC (US)

Correspondence Address: Arlen L. Olsen, Schmeiser, Olsen & Watts, Suite 201, 3 Lear Jet Lane, Latham, NY, 12110, US

(21) Appl. No.: 10/738,883

(22) Filed: Dec. 16, 2003

(30) Foreign Application Priority Data
Dec. 16, 2002 (EP) 02028056.6

(51) Int. Cl. B25D 1/00

(52) U.S. Cl. 173/2; 173/176

(57) ABSTRACT

The present invention relates to a signal processing and control device for a power torque tool. The signal processing and control device is adapted to be removably engageable with the body of said power torque tool, to be operable to process pulse signals representing pulses of torque being received from a torque sensor adaptor of the power torque tool in order to provide a shut-off signal to the power torque tool dependent on the received pulse signals, and to be powered by the power supply of the power torque tool.

### FIELD OF THE INVENTION

The present invention generally relates to an apparatus for the sensing of torque and the transmission of a torque-dependent signal to a remote measurement apparatus by a wireless technique. In this content, wireless transmission means signal transmission without the need of a cable or other like physical connection.

In particular, this invention relates to a signal processing and control device for a power torque tool. Furthermore, the invention relates to a kit comprising a torque sensor adaptor and a signal processing and control device.

The invention has particular application to measuring torque in a fastening tool in which torque is generated in pulses, for example by means of a pressure pulse, or in which an impact generates a torque impulse, and to controlling the power torque tool dependent on the measured torque. An example of such pulse torque generation is in power fastening tools for fastening or tightening nuts onto bolts or studs for example. Power fastening tools find application in many industries, a major one of which is automobile assembly.

### BACKGROUND OF THE INVENTION

Considerable attention has been given in the past to the measurement of torque generated in pulsed or impact-typed torque tools or power torque tools, respectively, and controlling operation of the tool to achieve a predetermined torque. Such tools may be sometimes referred to as powered torque wrenches. They have long been used for applying a tightening torque to fasten nuts to bolts, or similar operations.

Pulsed or impact-typed torque tools include two categories. One in which an impact generates a torque impulse such as a rotary hammer an anvil mechanisms, and the other in which a pulse of controlled characteristics is generated, such as by a pressure pulse generated with the aid of a piston and cylinder mechanism. In both categories, a train of successive torque pulses is generated to produce increasing torque on the load being tightened. Impact-type tools may be electrically or pneumatically driven (e.g. compressed air). Pressure-pulse-type tools may be hydraulically driven (e.g. oil) or electrically driven. The torque pulses are generated at one end of an output shaft and are transmitted to an adaptor at the other end configured to fit the load such as a nut or bolt head.

The measurement of torque applied to a fastening, such as a nut and bolt, has long presented problems in determining the point at which a desired torque value is achieved when using the pulse-type power torque tools. Among the techniques developed for measuring pulsed torque are those based on magnetic transducer technology in which a magnetized transducer is incorporated in or coupled to a torque transmission shaft in a power tool and torque-dependent magnetic field component is sensed by a non-contact sensor arrangement to develop a torque-representing signal which is transmitted by an electrical connection to signal-processing circuit. The complete torque measuring assembly can be mounted in the tool. An alternative is to transmit a torque-dependent signal from the tool to a remote signal processing circuit.

British patent application GB 022296.6 filed on Sep. 25, 2002 which is incorporated herein by reference discloses a torque sensor adaptor that emanates a field carrying a torque-dependent signal which is received by a remote receiver unit.

The present invention is based on the problem to control the operation of existing conventional power torque tools when a predetermined torque is reached based on the torque information obtained by a torque sensor adaptor.

The present invention is specified by the features of the claims.

In particular, the present invention provides a signal processing and control device for a power torque tool, wherein the signal processing and control device is removably engageable with the body of a power torque tool such that said device is operationally coupled to the power supply of said power torque tool, wherein the signal processing and control device is operable to process pulse signals representing pulses of torque being received from a torque sensor of said power torque tool, in order to provide a power supply shut-off signal to the power torque tool dependent on the received pulse signals, and wherein the signal processing and control device is powered by the power supply of said power torque tool.

In other words, the signal processing and control device according to the present invention is removably engageable with the body of a conventional power torque tool so that it can be interfaced, for example, between the detachable compressed air supply and the handle-bar of the power torque tool. Alternatively, in case a battery pack is used to power the power torque tool, the battery pack is provided in the housing of the signal processing and control device, and the power supply to the power torque tool is controlled by the signal processing and control device dependent on the measured torque. The interfaced signal processing and control device receives and processes the torque pulse signals and controls the power supply of the tool dependent on the received signals, i.e., the power supply is interrupted once a predetermined torque value has been reached.

The arrangement according to the present invention is advantageous since once the torque sensor adaptor and the signal processing and control device are attached to the power torque tool, there is a constant distance between the “transmitter”, i.e. the torque sensor adaptor, and the “receiver”, i.e. the signal processing and control device. Such a constant distance facilitates the signal processing since the received signals are not influenced by a changing distance between transmitter and receiver.

In the following, the torque sensing principle underlying the present invention is described in more detail.

For pulse tool and impact tool applications, the torque values are rapidly changing in the output shaft during the operation of the tool. In case a magnetically encoded power transmitting shaft is used for sensing the torque, the magnetic field profile at the encoding region of the shaft will change accordingly to the chances in the applied torque. Placing an inductor near the magnetically encoded region will convert the changes of magnetic flux into a flow of electrical current.

This electrical current generated by the individual impact torque pulses is in relation to the rate at which the magnetic flux is changing. For a given application, e.g. tightening a bolt in a hard-joint application, the impact-pulse characteristically remains constant during the whole operation (torque-slope remains constant for the tool). What does change is the time it takes for each impact pulse to reach its maximum peak. Initially, then the bolt is loose, i.e. un-tightened, the impact-torque pulses will have a very short rise-time before the maximum torque will be reached as the bolt will begin to turn. When the bolt is beginning to tighten-up, the tension forces in the bolt are increasing and with this the required torque forces to turn the bolt. This results in a longer raising time of the torque-building-up impact pulse. Equivalently, the generated amount of current in the coil will raise with the increase in impact-pulse-raising time. Therefore, the output current can be used as a sensor signal while no further active electronical components or additional electrical power is required.

The present invention is particularly advantageous in applications where the changes of torque values need to be monitored or measured, e.g., in hammer drilling heads and hammer tools in general, impact power tools (e.g., electrically powered, hydraulic powered tools), pulse tools, combustion engines (i.e., monitoring torque in the crank shaft generated by each cylinder, and combustion engine misfiring detection). Furthermore, the present invention is applicable in stationary applications, i.e. the shaft does not rotate, or dynamic applications, i.e. the shaft does rotate in any direction.

The invention will be further described with reference to the accompanying drawings:

### BRIEF DESCRIPTION OF THE DRAWINGS

FIG. 1 shows a diagrammatic view of a torque sensor adaptor kit comprising a torque sensor adaptor and a signal processing and control device according to the present invention for a conventional power torque tool;

FIGS. 2a, b show a detailed schematic view of the connection of the air line directly with the tool (FIG. 2a), and with the control device interfaced (FIG. 2b);

FIGS. 3a, b show an alternative embodiment of the invention where the signal processing and control device is added to a battery pack;

FIGS. 4a,b show schematic views of a torque sensor adaptor for use with a signal processing and control device according to the present invention; and

FIG. 5 shows a physical implementation of a wireless torque sensor adaptor in a tool adaptor.

### DETAILED DESCRIPTION OF PREFERRED EMBODIMENTS

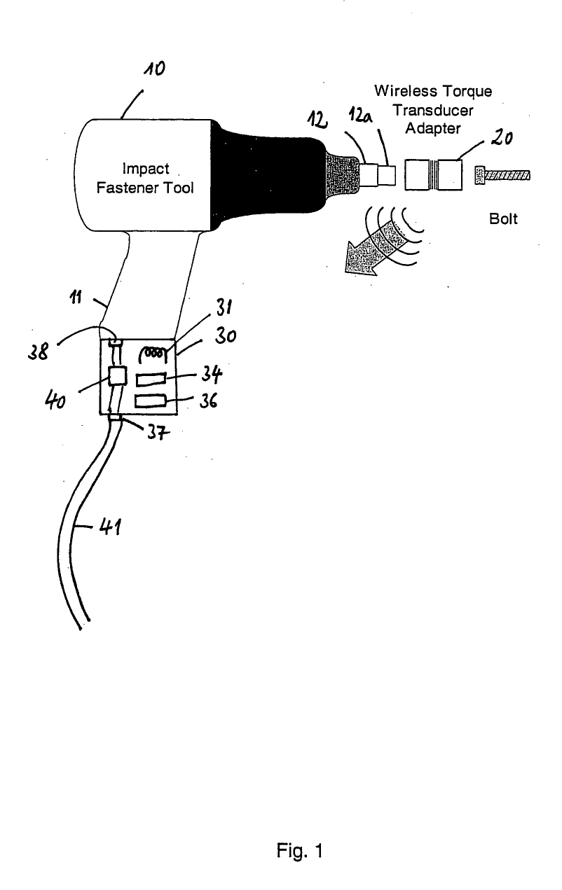

FIG. 1 shows a diagrammatic view of a torque sensor-adaptor kit comprising a torque sensor adaptor and a signal processing and control device according to the present invention. FIG. 1 shows a conventional power torque tool 10, such as an impact-type fastening tool which provides torque pulses at an output shaft 12. The tool illustrated in FIG. 1 is powered by compressed air through line 41. It is conventional to fit a load-engaging adaptor on the distal end 12a of the shaft 12 for transmitting torque to the load, e.g., a nut or bolt head.

In accordance with one aspect of the present invention, a kit including a torque sensor adaptor 20 is provided to enable torque measurement and control to be exercised on a conventional pulsed torque tool not containing such provision. The adaptor 20 couples to the tool output shaft at one end and receives a conventional passive adaptor for engaging a load at the other end. The adaptor incorporates a torque transducer arrangement using a magnetic-based torque transducer element. The adaptor 20 can be characterized as an active device in contrast to prior passive devices. However, the adaptor is magnetically active as regards torque sensing but is passive in the sense of requiring no electrical power supply for operation. In the kit illustrated in FIG. 1, the torque-dependent signals from the sensor arrangement in adaptor 20 are supplied in wireless form such as light (visible or otherwise), radio, sound, induction etc. to the signal processing and control device 30 which in turn supplies a shut-off signal to an air-valve unit 40 acting in line 41. The device 30 may include a display 34, e.g., an LCD display for displaying relevant parameters, and may also include a manually actuable keypad 36 for entering control instructions and data to a programmed microprocessor (not shown) housed in device 30.

The signal processing and control device 30 is removably engageable with the body, for example, the handlebar 11 of the power torque tool, and receives pulse signals from the torque sensor adaptor that represent pulses of torque. These pulse signals are processed by the signal processing and control device in order to provide a shut-off signal to the power torque tool. In other words, the power supply to the power torque tool is interrupted by the control signal of the signal processing and control device 30 as soon as a torque threshold is reached. The signal processing and control device is powered by the power supply of the power torque tool 10. For example, in case of a pneumatically powered power torque tool, the compressed air supplied to the tool is used to generate electrical current, for example by means of a turbine, to power the control device. Preferably, the signal processing and control device 30 comprises an input portion 37 being connectable to a compressed air supply. This input portion 37 is identical to the input portion provided in the power torque tool so that the compressed air supply is connected to the device 30 instead of being connected directly to the power torque tool 10. Furthermore, the device 30 comprises an output portion 38 being connectable to the compressed air input portion of the power tool. In other words, the output portion of the device 30 is identical to the connector at the compressed air supply so that the device 30 can be perfectly interfaced between the compressed air supply and the power torque tool. Instead of directly entering the power torque tool, the compressed air first flows through the device 30, where the flow of the compressed air is controlled by means of a controllable air valve. The valve is controlled by the device 30 on the basis of the received and processed pulse signals from the torque sensor adaptor 20. Furthermore, as mentioned above, a turbine is preferably provided in the device 30 to power the components of the signal processing and control device 30.

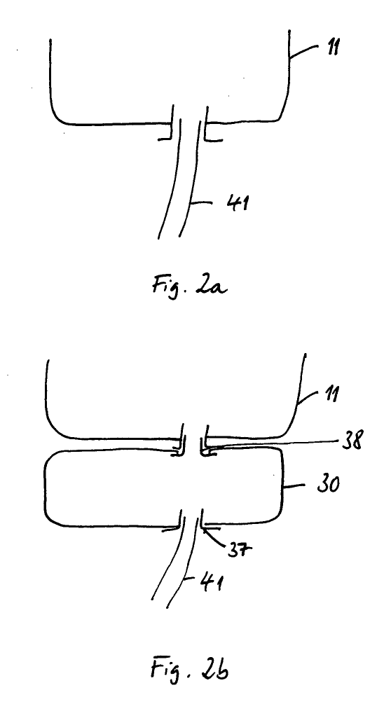

FIG. 2a shows the bottom part of the handlebar 11 of the power torque tool 10 with the air line 41 being directly connected to the tool. FIG. 2b shows the same configuration, however with the signal processing and control device 30 being interfaced between the tool 10 and the air line 41. It can particularly be seen in FIG. 2b how the input and output portions 37, 38 of the device 30 fit to the tool 10 and the air line 41, respectively.

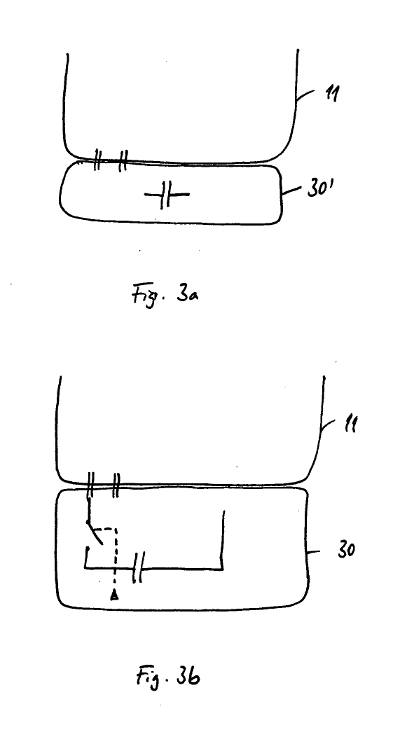

In an alternative embodiment (see FIGS. 3a, 3b), the device 30 is provided for a battery powered power torque tool. In this embodiment, the device 30 comprises a connector portion adapted for providing the removable engagement between the device 30 and the power torque tool 10. In other words, the connector portion of the device 30 corresponds to a connector portion of a conventional battery pack so that instead of the conventional battery pack 30′ the device 30 according to the present invention is connectable to the power torque tool. The battery pack for the power supply is then provided within the housing of the device 30, and signal processing and control device 30 controls the power supply of the power torque tool on the basis of the received and processed pulse signals representing the measured torque. The device 30 is powered by the battery pack. FIG. 3b shows the power switch that is controlled by a control signal to cut-off the supply of the tool motor when the desired torque has been reached.

An additional feature can be provided in the signal processing and control device 30 to count the number of torque pulses detected and processed as a measure of the use of the adaptor. An indicator can be displayed on the display screen when a predetermined number of pulses has been reached.

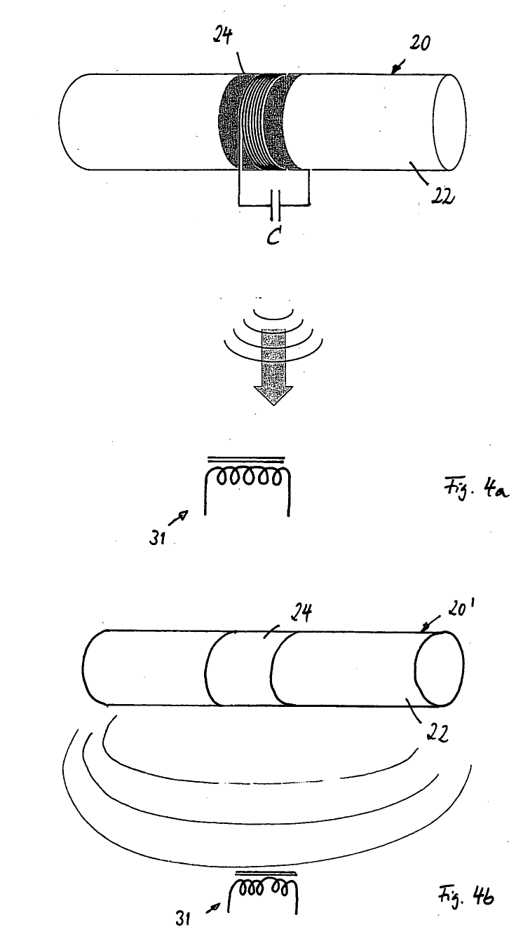

FIG. 4a shows in schematic form a torque sensor adaptor 20 (as disclosed in British patent application GB 0222296.6) which is constructed to transmit torque about its longitudinal axis. The torque sensor adaptor 20 comprises a shaft 22. The shaft 22 is essentially of circular cross-section. Furthermore, shaft 22 is magnetized at region 24, in order to provide a torque-sensitive transducer element or region which emanates a torque-dependent magnetic field. A signal/power generating inductor coil is would around the shaft. According to a first alternative, the inductor coil is wound tightly around the shaft and the coil then rotates with the shaft when the shaft is turning. Alternatively, the winding is less tight thus allowing the shaft to rotate freely while the inductor coil remains static. The current generated in the coil upon application of a torque to the shaft is used to power the wireless signal transmission to the signal processing and control device 30. For this reason, a resonance circuit is used for signal transmission, i.e. a capacitor C, for example, is connected to the inductor coil. When using a resonant circuit, the generated energy pulses will be converted in a higher, harmonic signal that is then received by the signal processing and control device. The torque sensor adaptor will become active immediately upon application of a torque pulse with sufficient energy to the shaft.

In practical applications, the coil may be in the range of 300 to 600 turns on a 15-18 mm diameter shaft of FV 250B steel. Other suitable steels are those known under the designations S155, S156 and 14 NiCo14. The steels have to be chosen for a combination of the mechanical properties required for the torque transmission system in which they are employed and their magnetic properties for sustaining the transducer region 24 and providing a torque-dependent magnetic field component.

It has been found that such a circuit can produce a resonance which causes the coil to emanate a field, which is detectable at some distance away. The resonance may serve to amplify the current generated in the coil. The resonance may be at a harmonic frequency related to the pulse period. The radiated field is detectable with the aid of a receiving coil 31 at the signal processing and control device of say 600 turns wound on a ferrite rod. The signal has, for example, been detected on a long-wave radio using a ferrite rod aerial, that is a radio tuned in the range 150-300 kHz. The emanated field from the coil has been detected over a range of 30 cm up to 1.5 m.

FIG. 4b shows an alternative embodiment of a torque sensor adaptor 20′ in schematic form. Here, no response circuit is provided. However, this type of adaptor also serves the intended purpose to provide a torque signal, although the signal frequency is not easy definable as it will change when the adaptor touches other metal parts.

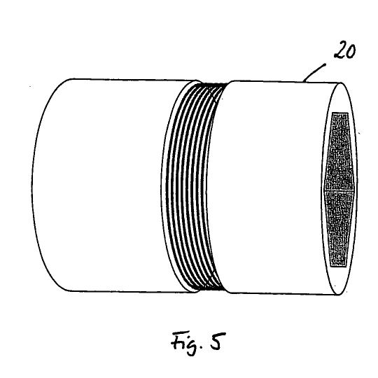

FIG. 5 shows the physical implementation of a wireless torque signal adaptor in a tool adaptor. The shown tool adaptor is used to interface between the square-end drive of the output shaft of the power torque tool and the bolt head. As can clearly be seen in FIG. 5, the inductor coil is located at a central portion of the adaptor.

1. Signal processing and control device (30) for a power torque tool (10), characterized in that
said signal processing control device (30) is removably engageable with the body of said power torque tool (10) such that said device is operationally coupled to the power supply of said power torque tool;
said signal processing and control device (30) is operable to process signals representing pulses of a torque being received from a torque sensor of said power torque tool (10) in order to provide a shut-off signal to the power torque tool (10) depending on the received pulse signals; and
said signal processing and control device (30) is powered by the power supply of said power torque tool (10).

2. The signal processing and control device (30) according to claim 1, wherein said power torque tool (10) is a pneumatically powered power torque tool.

3. The signal processing and control device (30) according to claim 2, comprising an input portion being connectable to a compressed air-supply, and an output portion being connectable to the compressed-air input portion of said power torque tool (10).

4. The signal processing and control device (30) according to claims 2 or 3, further comprising a controllable air valve, being controlled by said shut-off signal.

5. The signal processing and control device (30) according to claims 2, 3 or 4, further comprising a turbine for electrical power supply to the device (30), said turbine being powered by compressed air.

6. The signal processing and control device (30) according to claim 1, wherein said power torque tool (10) is electrically powered.

7. The signal processing and control device (30) according to claim 6, wherein said power torque tool (10) is battery powered.

8. The signal processing and control device (30) according to claim 6 or 7, comprising an output portion for electrical power supply being connectable to the power supply input portion of the power torque tool (10).

9. The signal processing and control device (30) according to claim 8, wherein the electrical power supply to the power torque tool is controlled by said shut-off signal.

10. The signal processing and control device (30) according to any of claims 6 to 9, wherein the electrical power supply to the power torque tool (10) is used to provide electrical power to said device (30).

11. The signal processing and control device (30) according to any of claims 1 to 10, comprising a receiver for receiving said pulse signals from said torque sensor, and further comprising a micro controller for processing said received pulse signals, and for providing said shut-off signal.

12. The signal processing and control device (30) according to claim 11, wherein said receiver is adapted for wireless communication with said torque sensor.

13. The signal processing and control device (30) according to any of claims 1 to 12, comprising a display means.

14. The signal processing and control device (30) according to any of claims 1 to 13, comprising a keypad.

15. The signal processing and control device (30) according to any of claims 1 to 14, wherein said device (30) is operable to process pulse signals representing pulses of torque and is responsive to the amplitude of each pulse signal with reference to the quiescent signal level on which it is imposed.
